(19) United States
(12) Patent Application Publication
(10) Pub. No.: US 2008/0192949 A1
(43) Pub. Date: Aug. 14, 2008

(54) Active noise elimination electronic system

(75) Inventor: Kun Yu Lin, Taipei (TW)

Correspondence Address: BACON & THOMAS, PLLC, 625 SLATERS LANE, FOURTH FLOOR, ALEXANDRIA, VA, 22314, US

(73) Assignee: AMA Precision Inc., Taipei (TW)

(21) Appl. No.: 12/068,266

(22) Filed: Feb. 5, 2008

(30) Foreign Application Priority Data
Feb. 14, 2007 (TW) 096105466

(51) Int. Cl. G10K 11/16

(52) U.S. Cl. 381/71.8

(57) ABSTRACT

An active noise elimination electronic system is disclosed. The electronic system includes a housing, a first electronic device, a noise receiver, an error sensor, a sound actuator, and a microprocessor. The first electronic device is arranged in the housing. The noise receiver is arranged in the housing and is close to the first electronic device for collecting first noise generated by the first electronic device. The error sensor is arranged in the housing for collecting a feedback noise which is different from the first noise. The microprocessor is coupled to the noise receiver, the error sensor and the sound actuator, and controls the sound actuator to produce a second noise which phase is inverse the first noise according to the first noise and the feedback noise.

### BACKGROUND OF THE INVENTION

1. Field of the Invention

The invention relates to a noise elimination apparatus and, more particularly, to an active noise elimination electronic system.

2. Description of the Related Art

With the rapid development of information and electronic technology, various electronic products can meet the needs of our human lives and have become our daily necessities. For example, computers can provide us office and entertainment functions, such as data processing, numerical analysis, and playing multimedia audio/video, and air conditioners, washing machines, and dishwashers can help us with housework. Since the elements arranged in the electronic products generate much heat energy when the elements operate, air intakes and air outlets are often designed on the housings of the electronic products. This design will make the sound source inside the housing to generate and transmit noise outwardly through the air intakes and outlets.

Moreover, fans are also disposed in the electronic products to exhaust the heat to make the elements in the electronic products operate properly. However, noise is also generated with running of the cooling fans, which results in consumer's bad impression on the quality of products. Furthermore, internal elements in the electronic products, such as disk drivers, optical disc drivers, and motors, generate vibration when they are rotating and thereby generating noise, which is actually a problem of the electronic products.

To eliminate or reduce the noise, a traditional way is to use passive soundproof material or shockproof pad to reduce noise. The main principle is fixing passive soundproof material or sound absorptive material around the noise source to isolate or absorb part of the noise. It is difficult to perform due to the limited space inside the electronic product. Moreover, the benefit of this method is often not good for low-frequency noise source.

In known patent literature, USPA 2003/0052807 “the '807 publication”) discloses a noise cancellation apparatus and method. The '807 publication positions a microphone near noise source inside a computer case to receive the noise generated by elements inside the computer. Next, the received noise is processed and analyzed to determine the waveform of the noise. After that, the audio apparatus of the computer (such as an audio card or a louder speaker) is utilized to generate noise whose phase is inverse to the noise mentioned above, and further to cancel waveform of the noise mentioned above. However, because the '807 publication utilizes a microphone to collect noise, in order to detect the noise exactly, the above microphone should be positioned near the noise source, such as a fan of the power supply in the computer. This method makes the microphone disposed near the fan of the power supply unable to collect noise which is far away from the microphone.

For example, the power supply is often assembled at the back of the computer system, but the hard disk drive and the CD-ROM driver are often assembled near the front panel of the computer housing. Therefore, the microphone may be unable to effectively receive noise generated by the hard disk driver and the CD-ROM driver. Therefore, this method is unable to cancel the noise around the front panel and disturb users.

Moreover, discrete tones within narrow frequency span caused by vibration generated by the elements of the computer are hard to be detected by the microphone. Therefore, the vibration waveform which is only collected by the microphone is easy to distort, and the corresponding inverse noise thus generated may not cancel the noise caused by vibration generated by the elements of the computer effectively.

### SUMMARY OF THE INVENTION

An objective of the invention is to provide an active noise elimination electronic system to reduce noise of electronic device and cancel discrete tone whose frequency is partly narrow, and further to improve sound quality of the electronic device.

To solve the above problem, an embodiment of the invention is to provide an active noise elimination electronic system. The electronic system includes a housing, a first electronic device, a noise receiver, a sound actuator, an error sensor, and a microprocessor. The first electronic device is arranged in the housing. The noise receiver is arranged in the housing and is close to the first electronic device for collecting first noise generated by the first electronic device. The error sensor is arranged in the housing for collecting a feedback noise which is different from the first noise. The microprocessor is coupled to the noise receiver, the error sensor and the sound actuator. The microprocessor controls the sound actuator to produce a second noise which phase is inverse to the first noise according to the first noise and the feedback noise.

In one embodiment, the housing includes an operating panel and the error sensor is arranged close to the operating panel.

In one embodiment, the noise receiver collects signals of the first noise generated by the first electronic device and transmits the signals to the microprocessor, then the microprocessor drives the sound actuator to generate the second noise (anti-noise); finally, the error sensor detects the noise level after control and feeds back the results to the microprocessor to improve the control result by optimizing controller.

In one embodiment, the noise receiver may be a microphone, an accelerometer, or a piezoelectric transducer. When the first noise generated by the first electronic device is vibrating noise, the accelerometer or PZT is often used as a noise receiver.

In one embodiment, the sound actuator may be a speaker or a vibrator. When the first noise is generated by vibration of a flexible mechanism, the sound actuator is a vibrator to change the vibration of the mechanism and further to improve radiant noise induced by the vibration.

In one embodiment, the error sensor may be a microphone, an accelerometer, or a piezoelectric sensor.

In one embodiment, the microprocessor is to adjust the second noise according to the first noise and the feedback noise until the feedback noise collected by error sensor is less than a preset threshold value.

### BRIEF DESCRIPTION OF THE DRAWINGS

FIG. 1 is an architecture diagram showing the system according to an embodiment of the invention.

FIG. 2 is a diagram showing how an electronic system of the preferred embodiment of the invention is applied in an air conditioner.

FIG. 3 is a control flowchart showing an embodiment of the invention;

FIG. 4 is a diagram showing a model waveform of the noise collected by an active noise elimination electronic system of the preferred embodiment of the invention.

FIG. 5 is a diagram showing another model waveform of the noise collected by an active noise elimination electronic system of the preferred embodiment of the invention.

FIG. 6 is an architecture diagram showing an active noise elimination electronic system according to another embodiment of the invention.

FIG. 7 is a diagram showing how an active noise elimination electronic system is applied in a computer.

### DETAILED DESCRIPTION OF THE EMBODIMENTS

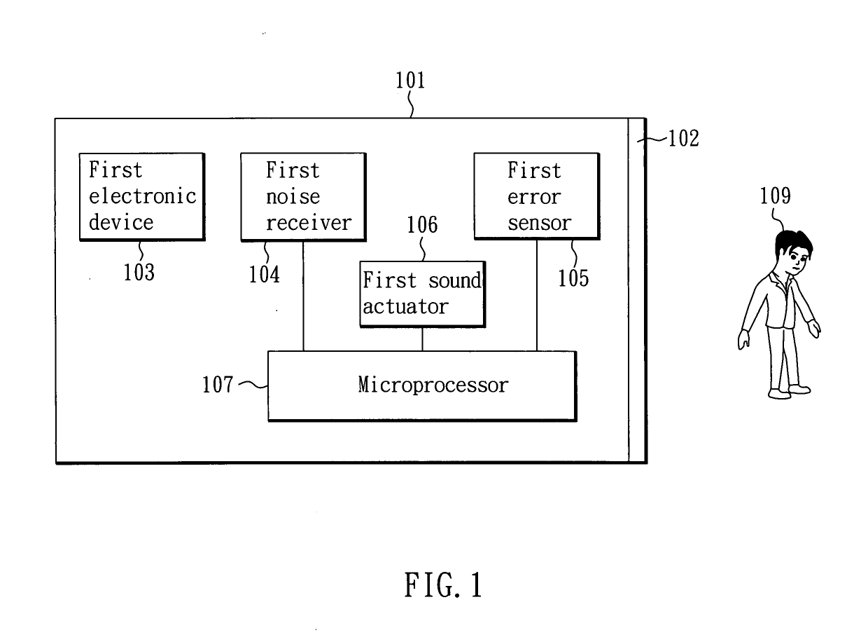

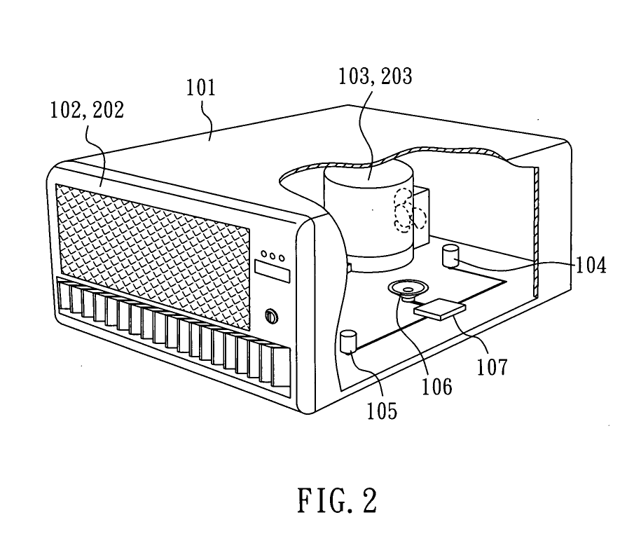

Please refer to FIG. 1 and FIG. 2 for details about embodiments of the invention, wherein FIG. 1 is an architecture diagram showing the system according to one embodiment of the invention, and FIG. 2 is a diagram showing how an electronic system of the one embodiment of the invention is applied in an air conditioner. In FIG. 1 and FIG. 2, the electronic system includes a housing 101 including an operating panel 102 to provide an operating interface for one user 109, such as an operating panel 202 of the air conditioner. The housing 101 includes a first electronic device 103, a noise receiver 104, a first error sensor 105, a first sound actuator 106, and a microprocessor 107.

The first electronic device 103, such as a compressor 203, generates noise during operation. The first noise receiver 104, such as a microphone, is disposed close to the first electronic device 103 to accurately collect the noise generated during the operation of the first electronic device 103.

The first error sensor 105, such as a microphone, is disposed close to (disposed on) the operating panel 102 of the housing 101, or in the housing 101 and close to the operating panel 102. The operating panel 102 often faces the user 109 who is near the operating panel 102; therefore, the first error sensor 105 can collect the feedback noise close to which is felt by the user 109. Notably, the feedback noise is different from the first noise mentioned above.

The first sound actuator 106, such as a speaker, may be disposed arbitrarily in the housing 101.

The microprocessor 107 mentioned above is coupled to the first noise receiver 104, the first error sensor 105, and the first actuator 106 to drive the first actuator 106 to generate a second noise (anti-noise) according to the signals of the first noise generated by the first electronic device 103 and collected by the first noise receiver 104. Afterwards, the first error sensor 105 detects control results and feeds back the performance to the microprocessor to improve the control result by optimizing control.

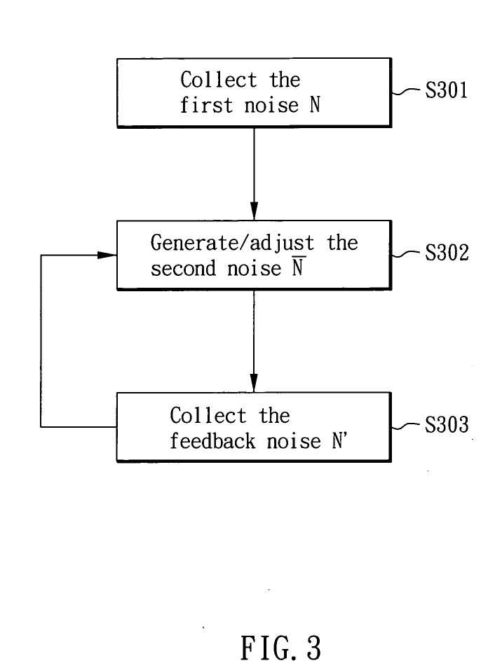

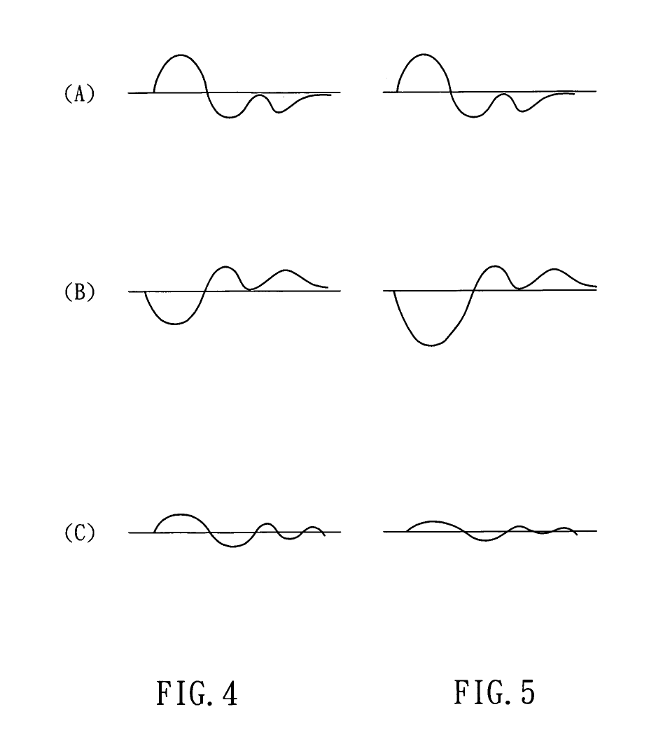

Please refer to FIG. 3 which is a control flowchart of the microprocessor 107. First, the first noise receiver 104 collects the first noise N (Step S301). (A) of FIG. 4 shows an example of the waveform of the received first noise. Secondly, the second noise N̅, whose phase is inverse to that of the first noise, is generated according to the first noise N received by the first noise receiver 104 (Step S302). (B) of FIG. 4 shows the second noise N̅, by which the first noise N is cancelled out. Afterwards, the first error sensor 105 receives the feedback noise N′ close to the user (Step S303). (C) of FIG. 4 shows the waveform of feedback noise N′. Then the microprocessor 107 adjusts the second noise N̅ according to the feedback noise N′ collected by the first error sensor 105 (Step S302). The second noise N̅ is adjusted until the feedback noise N′ received by error sensor is less than a preset threshold value. Therefore, this can reduce the trouble noise brought to the user.

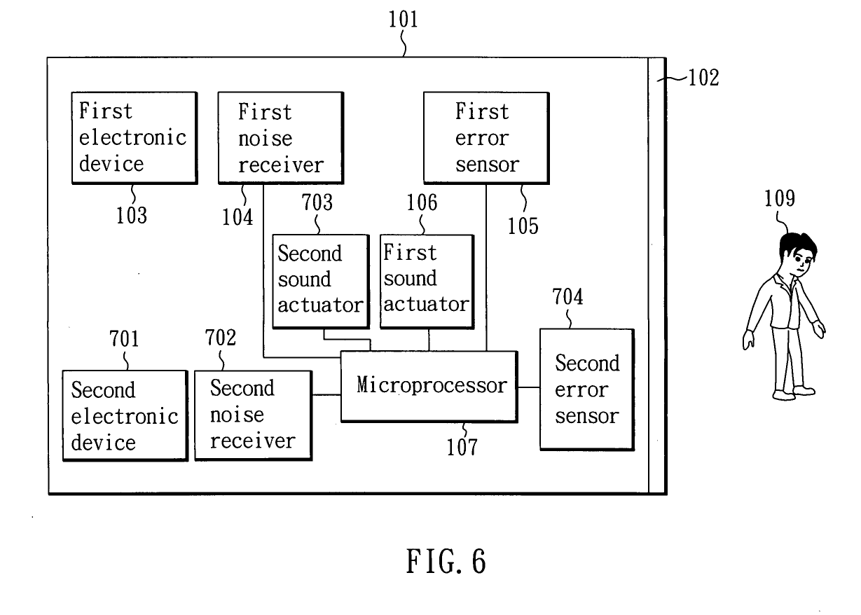

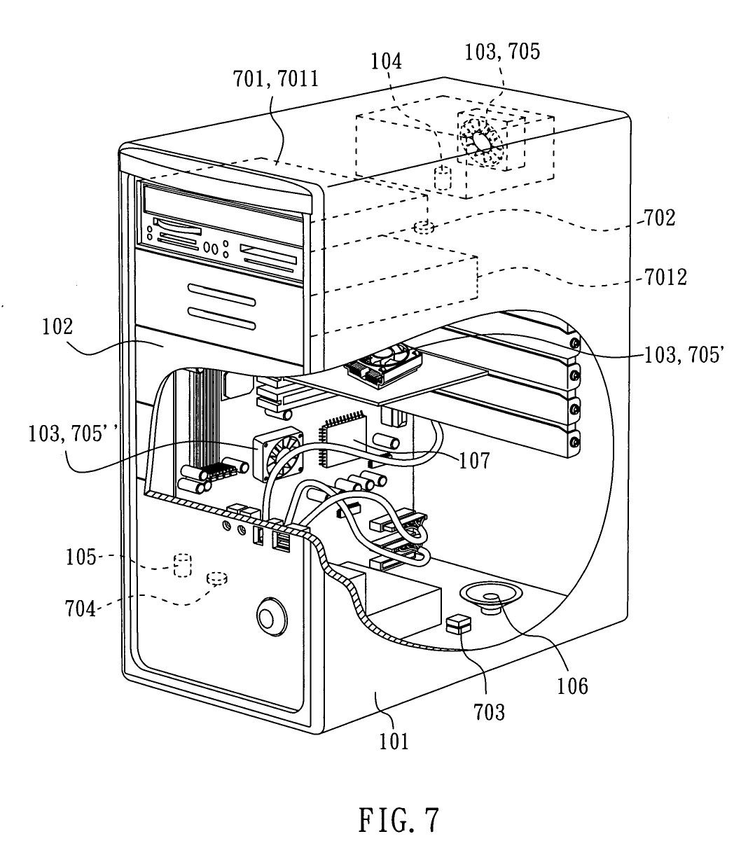

FIG. 6 is an architecture diagram showing an active noise elimination electronic system according to another embodiment of the invention. FIG. 7 is a diagram showing how an active noise elimination electronic system is applied in a computer. As shown in the figures, an electronic system includes a housing 101 including an operating panel 102 for the operation of the user 109. The housing 101 includes at least a first electronic device 103, at least a first noise receiver 104, at least a first error sensor 105, at least a first sound actuator 106, a microprocessor 107, at least a second electronic device 701, at least a second noise receiver 702, at least a second sound actuator 703, and at least a second error sensor 704.

The first electronic device 103 mentioned above, such as a power fan 705, a graphic card fan 705′, or a CPU heat sink fan 705″, may generate noise during operation. The first noise receiver 104 mentioned above, such as a microphone, is disposed close to the first electronic device 103 to rightly collect the noise generated during the operation of electronic device 103.

The second electronic device 701 mentioned above, such as a CD-ROM drive 7011 or a hard disk 7012, may generate noise during operation. The second noise receiver 702, such as an accelerometer or a piezoelectric sensor, is disposed close to the second electronic device 701 to rightly detect the third noise generated during the operation of the second electronic device 701. In this embodiment, the third noise is low-frequency vibration noise.

The first error sensor 105 mentioned above, such as a microphone, is disposed close to the operating panel 102 of the housing 101, or in the housing 101 and close to the operating panel 102. The second error sensor 704, such as an accelerometer or a piezoelectric sensor, is disposed close to the operating panel 102 of the housing 101, or in the housing 101 and close to the operating panel 102. The user 109 is often near to the operating panel 102, therefore, the first error sensor 105 and the second error sensor 704 can collect the feedback noise and feedback vibration close to which is felt by the user 109.

The first sound actuator 106 such as a louder speaker, the second sound actuator 703 such as a vibrator, the sound actuator 106 and the second sound actuator 703 may be disposed arbitrarily in the housing 101.

The microprocessor 107 is coupled to the first noise receiver 104, the first error sensor 105, the first sound actuator 106, the second noise receiver 702, the second sound actuator 703, and the second error sensor 704. Based on the first noise collected by the first noise receiver 104, the third noise (low-frequency vibration) collected by the second noise receiver 702, the feedback noise collected by the first error sensor 105, and the feedback noise collected by the second error sensor 704 (low-frequency feedback vibration), the microprocessor 107 controls the first sound actuator 106 to output a second noise whose phase is inverse to that of the first noise and controls the second sound actuator 703 to output the fourth noise (also a low-frequency vibration) whose phase is inverse to that of the third noise, and further to reduce source noise and vibration. Moreover, the microprocessor 107 adjust the second noise and the fourth noise according to the feedback noise generated by the first error sensor 105 and the second sensor 704, and the adjust method is similar to that of the previous embodiment.

To sum up, via providing a microphone or vibration sensor close to user, the invention collects and detects the noise and vibration similar to that is felt by the users and feeds back them to adjust noise canceling the waveform and vibration cancel waveform, and this can cancel or reduce noise to make the user avoid being disturbed.

The above embodiments are merely embodiments; the claimed scope of the invention should base on the claims but not be limited to the description of the preferred embodiments described above.

What is claimed is:

1. An active noise elimination electronic system, comprising:
a housing;
a first electronic device arranged in the housing;
a noise receiver arranged in the housing and close to the first electronic device for collecting a first noise generated by the first electronic device;
a sound actuator;
an error sensor arranged in the housing for collecting a feedback noise different from the first noise; and
a microprocessor coupled to the noise receiver, the sound actuator, and the error sensor and be used to control the sound actuator to generate a second noise which phase is inverse to the first noise based on the first noise collected by the noise receiver and the feedback noise collected by the error sensor.

2. The electronic system according to claim 1, wherein the housing comprises an operating panel and the error sensor is arranged close to the operating panel.

3. The electronic system according to claim 1, wherein the noise receiver is a microphone, an accelerometer, or a piezoelectric sensor.

4. The electronic system according to claim 1, wherein the noise receiver is an accelerometer and the noise generated by the first electronic device is vibrating noise.

5. The electronic system according to claim 1, wherein the sound actuator is a speaker or a vibrator.

6. The electronic system according to claim 4, wherein the sound actuator is a vibrator, and the second noise generated by the vibrator is vibrate noise.

7. The electronic system according to claim 1, wherein the error sensor is a microphone, an accelerometer, or a piezoelectric sensor.

8. The electronic system according to claim 1, wherein the microprocessor adjusts the second noise according to the first noise and the feedback noise until the feedback noise collected by the error sensor is less than a preset threshold value.

9. The electronic system according to claim 1, wherein the housing comprises an operating panel and the error sensor is arranged in the housing and is close to the operating panel.
